(19) United States
(12) Patent Application Publication
(10) Pub. No.: US 2018/0160077 A1
(43) Pub. Date: Jun. 7, 2018

(54) System, Method and Software for Producing Virtual Three Dimensional Avatars that Actively Respond to Audio Signals While Appearing to Project Forward of or Above an Electronic Display

(71) Applicant: Maxx Media Group, LLC, Philadelphia, PA (US)

(72) Inventor: Richard S. Freeman, Philadelphia, PA (US)

(73) Assignee: Maxx Media Group, LLC

(21) Appl. No.: 15/482,699

(22) Filed: Apr. 7, 2017

Related U.S. Application Data
(60) Provisional application No. 62/319,792, filed on Apr. 8, 2016.

(51) Int. Cl. H04N 7/15; H04N 13/04; H04N 13/02; H04N 13/00; G10L 15/22

(52) U.S. Cl. CPC H04N 7/157; H04N 13/0459; H04N 13/0275; G10L 2015/223; H04N 13/0055; G10L 15/22; H04N 13/0497

(57) ABSTRACT

A system and method of providing a virtual avatar to accompany audio signals being broadcast from an electronic device that has a display screen. A virtual avatar model is created. The virtual avatar model is altered in real time in response to audio signals being broadcast from the electronic device. A 3D stereoscopic or auto-stereoscopic video file is created using the virtual avatar model while the virtual avatar model is responding to the audio signals. The 3D video file is played on the display screen of the electronic device. When viewed, the 3D video file shows an avatar that appears, at least in part, to a viewer to be three-dimensional. Furthermore, the avatar appears to extend out from the display screen. The result is a three-dimensional avatar that appears to extend out of a display screen, wherein movements of the avatar are synchronized to audio signals that are being broadcast.

### RELATED APPLICATIONS

This application claims the benefit of U.S. Provisional Patent Application No. 62/319,792, filed Apr. 8, 2016.

### BACKGROUND OF THE INVENTION

### 1. Field of the Invention

In general, the present invention relates to systems and methods that are used to create virtual avatars and/or virtual objects that are displayed when a user interacts with a computer interface. More particularly, the present invention relates to virtual avatars and/or virtual objects that appear to project vertically above or in front of a display screen and are viewed while listening to and/or while speaking to an audio signal broadcast or an audio communication.

### 2. Prior Art Description

People interact with computers for a wide variety of reasons. As computer software becomes more sophisticated and processors become more powerful, computers are being integrated into many parts of everyday life. In the past, people had to sit at a computer keyboard or engage a touch screen to interact with a computer. In today's environment, many people interact with computers merely by talking to the computer. Various companies have programmed voice recognition interfaces. For example, Apple Inc., has developed Siri® to enable people to verbally interact with their iPhones®. Amazon Inc. has developed Alexa® to enable people to search the world wide web and order products through Amazon®.

Although interacting with a computer via a voice recognition interface is far more dynamic than a keypad or touch pad, it still has drawbacks. When two humans communicate face to face, many of the communication cues used in the conversation are visual in nature. The manner in which people move their eyes or tilt their heads provides additional meaning to words that are being spoken. When communications are purely based on audio signals, such as during a phone call, much of the nuance is lost. Likewise, when a computer communicates with a human through an audio interface, nuanced information is lost.

In order for a computer to provide a visual communication cue or response, it must provide an image of a person or object through which it can communicate or provide an active response. A virtual image of a person in a computer-generated environment is commonly called an avatar.

In the prior art, there are many systems that use avatars to transmit visual communication cues. In U.S. Patent Application Publication No. 2006/0294465 to Ronene, an avatar system is provided for a smart phone. The avatar system provides a face that changes expression in the context of a conversation. The avatar can be customized and personalized by a user.

A similar system is found in U.S. Patent Application Publication No. 2006/0079325 to Trajkovic which shows an avatar system for smart phones. The avatar can be customized, where aspects of the avatar are selected from a database.

U.S. Patent Application Publication No. 2013/0212501 to Anderson presents an avatar system that enables a computer, such as a personal computer, to provide visual cues to a user who is interacting with the computer. The avatar is customizable and changes with changing context in the communication.

An obvious problem with such prior art avatar systems is that the avatar is two-dimensional. Furthermore, the avatar is displayed on a screen that may be less than two inches wide. Accordingly, many of the visual cues that can be performed by the avatar can be difficult to see and easy to miss.

Little can be done to change the screen size on many devices such as smart phones. However, many of the disadvantages of a small two-dimensional avatar can be minimized by presenting an avatar that is three-dimensional. This is especially true if the three-dimensional effects designed into the avatar cause the avatar to appear to project out of the plane of the display. In this manner, the avatar will appear to project above or forward of the smart phone or other device during a conversation.

The best avatar would be a virtual avatar that appears as a stereoscopic or auto-stereoscopic image that projects forward of or in front of the plane of a display screen. The display screen can be placed in a vertical position common to televisions or desktop computer displays whereby the viewer would look straight ahead at the display. Alternatively, a display screen can be placed horizontally in a flat position somewhat in front of the viewer, whereby the viewer would look downward at the display. In this position, the avatar would appear to project vertically from, or above the plane of the display screen.

Three-dimensional images that are presented in this manner are particularly useful in creating avatars or objects that can be functionally viewed and manipulated during cellular phone calls, video calls, cellular or video phone conferences, cellular or video business presentations, cellular or video product presentations, cellular or video instructional and/or training presentations, acting as a virtual receptionist, a virtual museum guide and more. The virtual image of the avatar or object appears to float in front of, or to stand atop the screen, as though the image is projected into the space in front of, or above the screen.

In the prior art, there are many systems that exist for creating stereoscopic and auto-stereoscopic images that appear three-dimensional. However, most prior art systems create three-dimensional images that appear to exist behind or below the plane of the electronic screen. That is, the three-dimensional effect would cause an avatar to appear to behind the screen of a smart phone. The screen of the smart phone would appear as a window atop the underlying three-dimensional virtual environment. With a small screen, this limits the effect of the avatar and its ability to provide visual communication cues.

A need therefore exists for creating an avatar that can be used to provide visual communication cues, wherein the avatar appears three-dimensional and also appears to extend out from the electronic display from which it is shown. That is, the three-dimensional avatar would appear to be projected forward of or vertically above the screen of the electronic display, depending upon the orientation of the display. This need is met by the present invention as described and claimed below.

### SUMMARY OF THE INVENTION

The present invention is a system and method of providing a virtual avatar or object to accompany audio signals being broadcast or to enhance any other form of audio communication from or to an electronic device that has a display screen. In the system, a virtual avatar model is created. The virtual avatar model is altered in real time in response to audio signals being broadcast from or to the electronic device. A 3D stereoscopic or auto-stereoscopic video file is created using the virtual avatar model while the virtual avatar model is responding to the audio signals.

The 3D video file is played on the display screen of the electronic device. When viewed, the 3D video file shows an avatar that appears, at least in part, to a viewer to be three-dimensional. Furthermore, the avatar appears to extend out from the display screen. The result is a three-dimensional avatar that appears to extend out of a display screen, wherein movements of the avatar are synchronized or nearly synchronized to audio signals that are being broadcast.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a perspective view of an exemplary embodiment of a virtual image on an electronic display;

FIG. 2 is a side view of the virtual image of FIG. 1 showing how it appears to an observer;

FIG. 3 is a block flow diagram showing the general methodology of creating an avatar for use in the present invention;

FIG. 4 is a schematic of an overall system in which the present invention is utilized;

FIG. 5 shows the present invention system embodied as an information unit that interacts with an interactive program interface through a network connection or as a stand-alone unit.

### DETAILED DESCRIPTION OF THE DRAWINGS

Although the present invention system and method can be used to create and display virtual avatars and/or objects of many types, the embodiments illustrated shows the system creating an avatar of an exemplary person for the purposes of description and discussion. Additionally, although the avatar can be displayed on any type of electronic display, the illustrated embodiments show the avatar displayed on the screen of a smart phone and on a screen of a stationary display. These two embodiments are selected for the purposes of description and explanation only. The illustrated embodiments, however, are merely exemplary and should not be considered a limitation when interpreting the scope of the appended claims.

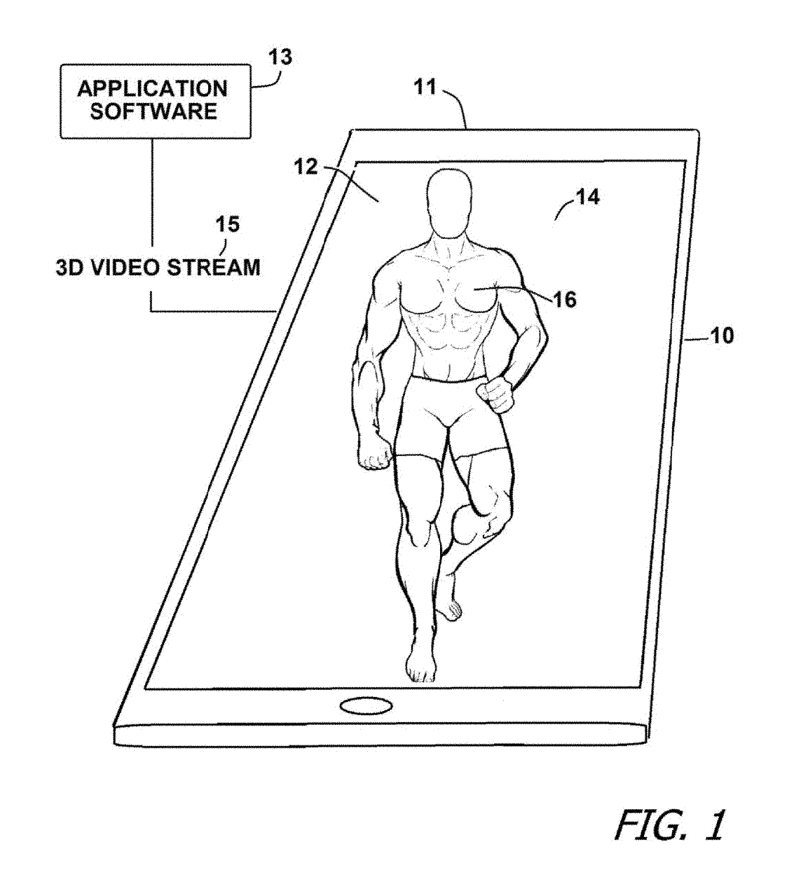

Referring to FIG. 1, an electronic device 10 is shown having a display screen 12. In the illustrated embodiment, the electronic device 10 is a smart phone 11 and the display screen 12 is the touch screen of the smart phone 11. However, it should be understood that the electronic device 10 can be a tablet computer, laptop, console display or any other such device that contains a programmable microprocessor and is capable of running application software 13 that is downloaded to or stored in the electronic device.

As will be explained, the application software 13 generates a 3D video steam 15 that is either stereoscopic or auto-stereoscopic in nature depending upon the display screen 12 where it is being viewed. The 3D video stream 15 presents a virtual scene 14 when viewed on the display screen 12. The virtual scene 14 includes an avatar 16. The virtual scene 14 has features that appear three-dimensional to a person viewing the virtual scene 14 on the display screen 12. The 3D video stream 15 can be generated using many methods. Most methods involve imaging an element in a virtual environment from two stereoscopic viewpoints. The stereoscopic images are superimposed and are varied in color, polarity or another manner that enables the stereoscopic images to be viewed differently between the left and right eye. For the stereoscopic images to appear to be three-dimensional to a viewer, the stereoscopic images must be viewed with specialized 3D glasses or viewed on a specialized display, such as an auto-stereoscopic display. In this manner, different aspects of the stereoscopic images can perceived by the left and right eyes, therein creating a three-dimensional effect.

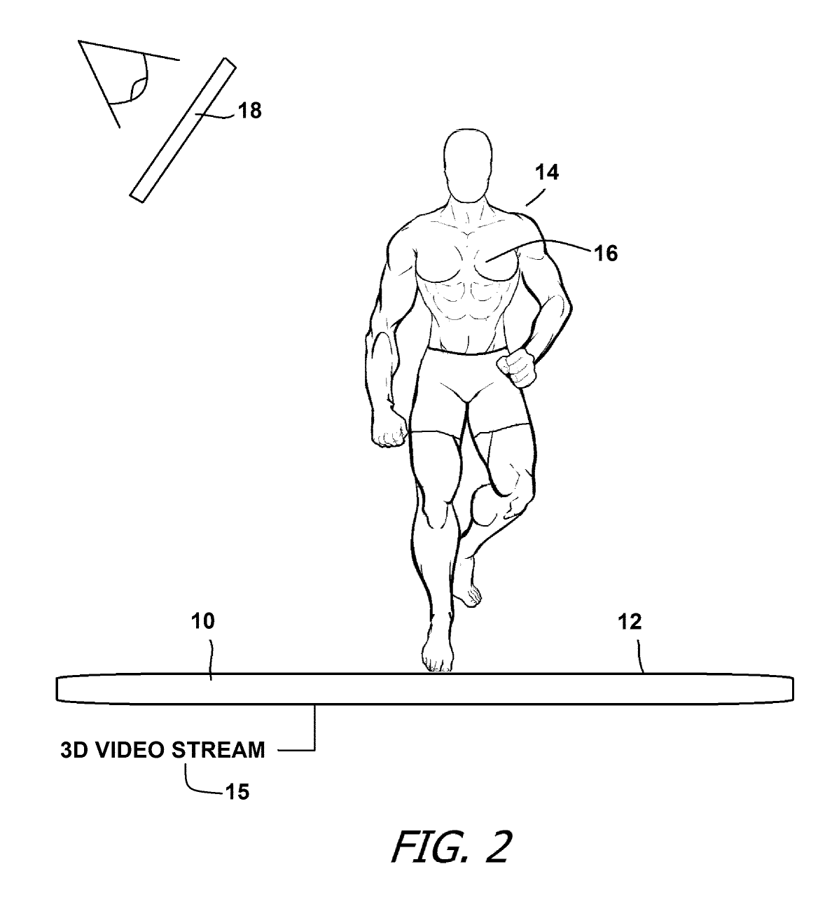

Referring to FIG. 2 in conjunction with FIG. 1, it will be understood that when a 3D video stream 15 is produced and the virtual scene 14 is properly viewed, the virtual scene 14 has features that appear to be three-dimensional. The features that appear to be three-dimensional appear to extend out of the display screen 12. That is, the features appear in front, or above, the display screen 12, depending upon the orientation of the display screen 12 relative to the viewer. The avatar 16 is preferably the primary object in the virtual scene 14 that is to appear three-dimensional. If the avatar 16 is a full body avatar, the avatar 16 appears to stand atop the display screen 12. Assuming that the display screen 12 is an ordinary LCD or LED display, the avatar 16 would have to be viewed through 3D glasses 18 in order to appear three-dimensional. It will be understood that if the display screen were an auto-stereoscopic display or a light field imaging display, no specialized glasses would be needed to view the three dimensional effects.

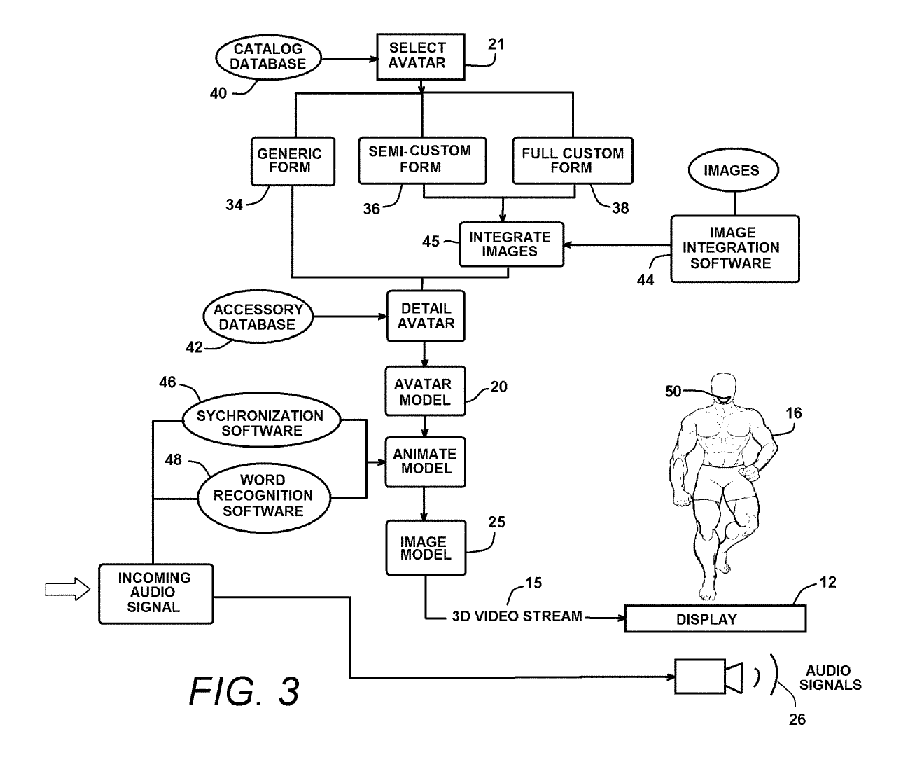

Referring to FIG. 3 in conjunction with FIG. 2, it will be understood that an avatar 16 is selected by a user. See Block 21. Once selected, a virtual model 20 of that avatar 16 is created. The virtual avatar model 20 is imaged with 3D imaging techniques to create the 3D video stream 15. See Block 25. If the virtual avatar model 20 of the avatar 16 moves, the image of the avatar model 20 is continuously processed frame by frame to create the 3D video stream 15. One technique for processing an image in a virtual environment so that it appears to be three-dimensional and also appears to extend out from a display screen is a technology that has been invented by the Applicant and is the subject of a separate co-pending patent application. The technique for creating the 3D video stream 15 is disclosed in co-pending patent application Ser. No. 15/481,447 to Freeman et al., the disclosure of which is herein incorporated by reference.

The purpose of the avatar 16 being displayed is to provide a means to show visual cues to what would otherwise be merely audio communications, such as a phone call. In order for the avatar 16 to provide relative visual cues, it must be updated in real time and remain in sync with the changing audio signals 26 being heard by a person viewing the avatar 16. Adapting an avatar 16 to provide visual cues to audible communications is a three-step process.

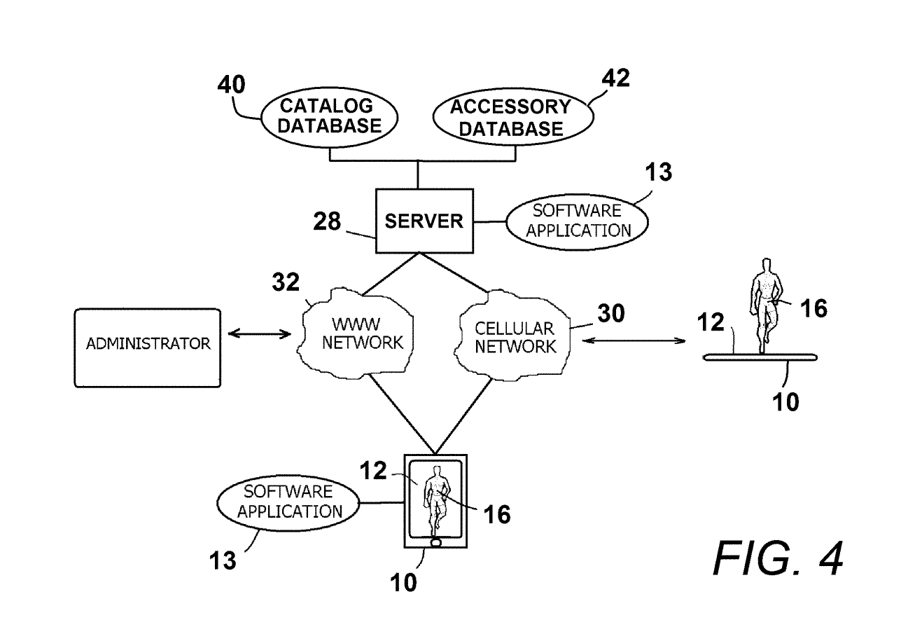

Referring to FIG. 4 in conjunction with FIG. 3, the first step for adapting an avatar 16 is explained. In the first step, the application software 13 needed to create the 3D video stream 15 must first be downloaded to the electronic device 10. The 3D video stream 15 that shows the avatar 16 is created using the software application 13. The electronic device 10 that contains the display screen 12 is used to access a server 28 through either a cellular network 30, a WiFi internet connection 32, or any other type of communication network system. Once in communication with the server 28, a software application 13 is downloaded onto the electronic device 10. The software application 13 can be a free download or a purchased application.

Once the software application 13 is downloaded onto the electronic device 10, the second step is to create or select a virtual avatar model 20 for use as the virtual subject of the 3D video stream 15. It will be understood that the general steps of selecting an avatar, Block 21, and creating a virtual avatar model 20 contain sub-steps. The software application 13, through the electronic device 10, instructs a user to choose a virtual avatar model 20. The virtual avatar model 20 can have a generic form 34, a semi-custom form 36, or a full custom form 38.

The generic form 34 of the avatar model 20 would be a selection from a menu of generic avatar models that are stored in an avatar catalog database 40 at the server 28. The generic form 34 can be a man, a woman, or any other creature or object, including licensed fantasy characters, virtual animals and virtual pets. The apparel and other accessories for the generic form 34 may be provided or may be selected. If not provided, various types of clothing, uniforms, equipment, and accessories may be selected from an accessory database 42 at the server 28.

The semi-custom form 36 is selected in the same manner as is the generic form 34. However, the face of the semi-generic form 34 is left blank on the virtual avatar model 20, or may be made to appear blank. A user then downloads one or more images of a face. This process can be dynamic, where different face images are used for different purposes. The images are modeled onto the blank face of the semi-custom form 36 using image integration software 44. See Block 45. There are several commercially available image integration software programs that enable a person to wrap a two-dimensional image of a face onto a three-dimensional avatar model. Such applications are exemplified by U.S. Patent Application Publication No. 2012/0113106 to Choi, entitled Method And Apparatus For Generating Face Avatar, the disclosure of which is herein incorporated by reference.

For generic forms 34 and semi-custom forms 36 of the virtual avatar model 20, the application software 13 provides a user with the ability to detail, personalize, and change the virtual avatar model 20 as desired, and as described above. Using the accessory database 42, a user can select hair length, hairstyle, hair color, skin color, and various other clothing and accessory options. Once the virtual avatar model 20 is complete, the virtual avatar model 20 is saved for use in animation and then for the generation of the 3D video stream 15.

The full custom form 38 of the virtual avatar model 20, can be created by downloading a full body scan or a picture set of the body of the user. After downloading such images of the user, the scans or pictures are virtually wrapped around the full custom form 38 using graphic integration software 44. Such avatar creation techniques are disclosed in U.S. Patent Application Publication No. 2012/0086783 to Sareen, entitled System And Method For Body Scanning And Avatar Creation, the disclosure of which is incorporated by reference. The full custom form 38 is dressed and has the general appearance, including such details as the appropriate hair length, hair color and skin color of the specific user since it is created from scans or photo files. Accessories can be added to the full custom form 38 using the accessory database 42.

The third step in adapting an avatar 16 to provide visual cues to audible communications is to create the 3D video stream 15 from the virtual avatar model 20 in real-time or near-time synchronization to audio signals 26. The virtual avatar model 20 itself has no artificial intelligence programming. Rather, the virtual avatar model 20 is a digital puppet that must be linked to a separate control element to control movement. The control elements for the virtual avatar model 20 are the audio signals 26 that the avatar 16 is being used to help communicate. Sound synchronizing programs 46 and/or word identification programs 48 are used to create changes in the virtual avatar model 20. Changes in the virtual avatar model 20 may include changes in facial expressions and/or changes in body movement. In a simple embodiment, the avatar model 20 is provided with a mouth 50. A sound synchronizing program 46 can be used to move the mouth 50 on the virtual avatar model 20 in synchronization with a voice in a conversation. Similarly, the volume and tone of the words being communicated can be detected. Depending if a person is speaking calmly or is yelling, preprogrammed movements in the head and body of the virtual avatar model 20 can be triggered. As such, a person can tell if a caller is speaking calmly or yelling just by looking at the body movements or facial expressions of the avatar 16 being displayed. Likewise, if music is playing, simple body movements in the virtual avatar model 20 can be set to the beat of the music. Accordingly, a person can tell if they have been placed on hold by viewing the avatar 16 dance to the on-hold music being played.

Using word recognition software 48, certain trigger words or phrases, such as “I love you”, can be identified. This can likewise trigger certain movement algorithms for the avatar model 20, and/or trigger various graphic effects to be added to the virtual three-dimensional scene along with the avatar model 20. The graphic effects that are added may include word balloons, emoticons, or other graphic images visually communicating the underlying tone and meaning of the speaker related to the message being verbally communicated, or to enhance the virtual scene in any other way. Animation software for avatars that is based upon audio signals is exemplified by U.S. Pat. No. 8,125,485 to Brown, entitled Animating Speech Of An Avatar Representing A Participant In A Mobile Communication, the disclosure of which is herein incorporated by reference.

The sound synchronization software 46 and the word recognition software 48 trigger preprogrammed changes in the virtual avatar model 20. However, the virtual avatar model 20 is a virtual digital construct. The virtual avatar model 20 must be used to create the 3D video stream 15 as the virtual avatar model 20 changes with the audio signals 26. As the virtual avatar model 20 changes with the audio signals 26, the virtual avatar model 20 is virtually imaged at a video frame rate of at least 30 frames per second. The result is the production of the 3D video stream 15. It is the 3D video stream 15 that is displayed on the display screen 12 of the electronic device 10. The 3D video stream 15 is either a stereoscopic video stream or an auto-stereoscopic video stream depending upon the design of the display screen 12. As such, when the 3D video stream 15 is viewed, the avatar 16 being presented appears three-dimensional when viewed with 3D glasses or when displayed on an auto-stereoscopic display without specialized glasses. Regardless, the avatar 16 will appear to extend forward or above the display screen when viewed in the proper manner.

The use of the avatar 16 is very useful when communicating between computers or between smart phones. The avatar 16 does not monitor the exact movements of a caller. Rather, the avatar 16 will move in response to the words and/or message communicated. The activation of the avatar 16 may be linked to a smart phone application so every time a certain person calls, the avatar 16 for that person is displayed. When a user calls another smart phone over the cellular network 30, the avatar 16 of the caller can be transmitted with the call as a data file. Alternatively, the avatar 16 can be retrieved by the recipient of the call from data stored in a previously downloaded software application. In this case, the recipient of the call has previously loaded the proper application software 13 into his/her phone. The caller's avatar 16 is selected and retrieved from the pre-installed application software, and appears when the call is answered, or when triggered by the recipient of the call. The avatar 16 of the person who placed the call will therefore appear on the smart phone of the person who was called. Likewise, either when placing the call, or when the call is answered, the avatar of the recipient of the call, will appear on the caller's smart phone.

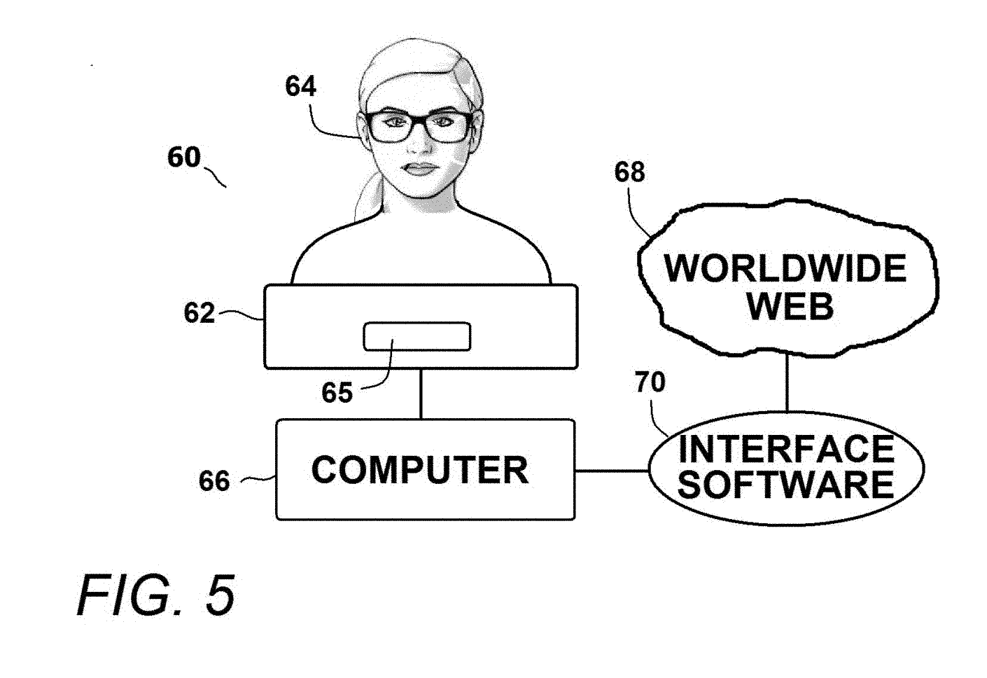

In the earlier embodiment, the avatar 16 is shown in use with a smart phone 11. Although the avatar 16 is good at providing visual cues to what would otherwise be verbal communication, other applications exist. Referring to FIG. 5, one such alternate application is shown. In this embodiment, an electronic device is provided that is a dedicated information unit 60. The information unit 60 can be placed in the lobby of a hotel, in museums, at tourist locations, at welcome centers, and the like. The information unit 60 has a display screen 62. An avatar 64 is displayed that extends out of the plane of the display screen 62. The display screen 62 can be a regular LCD or LED display. Alternatively, the display screen 62 can be an auto-stereoscopic display. If the display screen 62 is a regular LCD or LED display, then 3D glasses will be provided. If the display screen 62 is an auto-stereoscopic display, then no glasses are required to see the 3D effects.

In this embodiment, it will be noted that the avatar 64 is merely a bust and not a full body. This makes the features of the face more noticeable. The information unit 60 may be connected to a limited selection of informative answers. As such, when a person presses a “play” button 65 on the information unit, the information will play. Additionally, the information can be triggered to play by methods such as voice activation by viewers, sensors built into or near the information unit 60 to detect possible viewers, and other methods. The avatar 64 can be synchronized with the information played including realistic lip movement to words and facial expressions in context to the information relayed.

Alternatively, the information unit 60 can be integrated with a computer system 66 that is linked to the worldwide web 68. The computer system 66 can be loaded with an interactive computer interface 70 such as Siri® by Apple or Alexa by Amazon®. This will enable the information unit 60 to answer a large variety of questions. Since the questions are unknown and the replies unknown, the avatar 64 would use voice synchronization and word recognition software to alter the avatar 64 and interact with a user.

Additionally, in the same manner as described above, the avatar 64 can be scaled in size to display arms and hands. Word recognition algorithms can be used to trigger pre-programmed “signing” motions of the hands of the avatar 64, or of a set of hands only, to facilitate communications with a person who has a hearing deficit.

It will be understood that the embodiments of the present invention that are illustrated and described are merely exemplary and that a person skilled in the art can make many variations to those embodiments. All such embodiments are intended to be included within the scope of the present invention as defined by the claims.

1. A method of providing a virtual avatar to accompany audio signals being broadcast from an electronic device that has a display screen, said method comprising the steps of:
creating a virtual avatar model;
altering said virtual avatar model in response to said audio signals;
creating a stereoscopic video file by imaging said virtual avatar model from two virtual stereoscopic viewpoints while said virtual avatar model is responding to said audio signals; and
playing said stereoscopic video file on said display screen of said electronic device, wherein said stereoscopic video file shows an avatar image that, at least in part, appears to a viewer viewing said screen with a stereoscopic image viewer to be three-dimensional and to extend out from said display screen.

2. The method according to claim 1, wherein altering said virtual avatar model in response to said audio signals includes providing said virtual avatar model with a mouth and moving said mouth in response to said audio signals.

3. The method according to claim 1, wherein altering said virtual avatar model in response to said audio signals includes running a word recognition program and moving said virtual avatar model in a preselected manner as certain words are recognized in said audio signals.

4. The method according to claim 3, further including the step of adding supplemental virtual elements to said stereoscopic video file that are shown with said avatar image when certain words are recognized by said word recognition program.

5. The method according to claim 4, wherein creating a virtual avatar model includes selecting a generic avatar model from a database of avatar models and wrapping images of a face onto said generic avatar model.

6. The method according to claim 4, wherein creating a virtual avatar model includes wrapping images of a body onto said generic avatar model.

7. The method according to claim 1, wherein said electronic device is a smart phone and said audio signals are from a phone call received through said smart phone.

8. (canceled)

9. The method according to claim 1, wherein said display screen is an auto-stereoscopic display and said stereoscopic video file is formatted to play on said auto-stereoscopic display.

10. A method of providing a virtual avatar to accompany audio signals of a call being received from a caller on a smart phone with a display screen, said method comprising the steps of:
retrieving a virtual avatar model of an avatar that is assigned to said caller when said call is received from said caller;
altering said virtual avatar model in response to said audio signals contained in said call;
creating a stereoscopic video file by imaging said virtual avatar model from two virtual stereoscopic viewpoints in real time while said virtual avatar model is responding to said audio signals;
playing said stereoscopic video file on said display screen of said smart phone.

11. The method according to claim 10, wherein altering said virtual avatar model in response to said audio signals contained within said call includes providing said virtual avatar model with a mouth and moving said mouth in response to said audio signals contained within said call.

12. The method according to claim 10, wherein altering said virtual avatar model in response to said audio signals contained within said call includes running a word recognition program and moving said virtual avatar model in a preselected manner as certain words are recognized in said audio signals contained within said call.

13. The method according to claim 10, wherein retrieving a virtual avatar model includes retrieving said virtual avatar model from a database of avatar models that is accessible by said smart phone.

14. The method according to claim 10, wherein said 3D video file is selected from a group consisting of stereoscopic video files that appear three-dimensional when viewed through 3D glasses and auto-stereoscopic files that appear three dimensional to a naked eye.

15. A method of providing a virtual avatar to accompany audio signals being broadcast from an electronic device that has a display screen, said method comprising the steps of:
providing a virtual avatar model;
altering said virtual avatar model in response to said audio signals;
generating a stereoscopic video file by imaging said virtual avatar model from two virtual stereoscopic viewpoints while said virtual avatar model is responding to said audio signals;
playing said stereoscopic video file on said display screen of said electronic device, wherein said stereoscopic video file shows an avatar image that, at least in part, appears to a viewer of said screen to be three-dimensional when viewed through 3D glasses.

16. The method according to claim 15, wherein altering said virtual avatar model in response to said audio signals includes providing said virtual avatar model with a mouth and moving said mouth in response to said audio signals.

17. The method according to claim 15, wherein altering said virtual avatar model in response to said audio signals includes running a word recognition program and moving said virtual avatar model in a preselected manner as certain words are recognized in said audio signals.

18. The method according to claim 15, wherein providing a virtual avatar model includes selecting a generic avatar model from a database of avatar models.

19. The method according to claim 18, wherein providing a virtual avatar model includes customizing said generic avatar model with accessories selected from an accessory database.

20. The method according to claim 15, wherein said electronic device is a smart phone and said audio signals are from a phone call received through said smart phone.
